(19) United States
(12) Patent Application Publication
(10) Pub. No.: US 2007/0148381 A1
(43) Pub. Date: Jun. 28, 2007

(54) Bowl-shaped or plate-shaped component

(75) Inventor: Gerhard Moser, Perchtoldsdorf (AT)

Correspondence Address: Anton P. Ness, Esquire, 4092 Skippack Pike, P.O. Box 650, Skippack, PA, 19474, US

(73) Assignee: Siemens Transportation Systems GmbH & Co KG, Vienna (AT)

(21) Appl. No.: 11/650,381

(22) Filed: Jan. 5, 2007

(30) Foreign Application Priority Data
Jun. 30, 2005 (AT) PCT/AT05/00246
Jul. 7, 2004 (AT) A1151/2004

(51) Int. Cl. B31B 45/00

(52) U.S. Cl. 428/34.1; 428/223; 428/100; 428/99

(57) ABSTRACT

A bowl-shaped or plate-shaped structural element, consisting of a first layer (A), an intermediate layer (C), and a second layer (B), wherein the first layer (A) and the second layer (B) are profiles (1a, 1b) having anchorage couplers (2a, 2b) projecting into the intermediate layer (C), which couplers regionally interlock with the anchorage couplers (2a, 2b) associated with the respective opposite layer (A, B), and the space between the profiles and their anchorage couplers is filled with a material that is solid and cohesive per se.

### CROSS-REFERENCE TO RELATED APPLICATIONS

This application claims priority from PCT Application No. PCT/AT2005/000246 filed Jun. 30, 2005, in turn claiming priority from Austrian Patent Application A 1151/2004 filed Jul. 7, 2004.

1. Field of the Invention

The invention relates to a bowl-shaped or plate-shaped component, and more particularly a structural element, consisting of a first layer, a second layer, and an intermediate layer therebetween.

2. Background of the Invention

Components of this type, also known as structural elements, are used specifically in vehicle manufacture. Known construction methods involve so-called sandwich constructions in which a first layer of sheet metal or a metal profile imparts the major portion of strength to the construction. This first layer is usually the outer layer in vehicles such as railroad cars. The next layer is the intermediate layer, which serves mainly as a heat insulating and/or sound insulating layer. The inner layer serves mostly as an inner lining, and its function is often primarily decorative. The individual layers are firmly bonded to each other with, say, adhesives.

It is known that adhesive bonds tend to delaminate due to chemical and/or physical aging—a process that often does not occur until many years later. In railroad vehicle construction, where the life of the vehicles is 30 years or longer, the structural elements known in the prior art lead to problems that make it necessary to resort to other, more expensive structural elements, which frequently do not possess the desired heat insulating properties between the inner layer and the outer layer.

It is desired to provide a light-weight and/or thin-walled structural element, for example for railroad vehicles, having strength and insulating properties resistant to aging.

### BRIEF SUMMARY OF THE INVENTION

This object is achieved with a structural element of the aforementioned type in which, according to the invention, the first and second layers are profiles with anchorage couplers projecting into the intermediate layer, which regionally interlock with the anchorage couplers associated with the respective opposite layer, and the space between the profiles and their anchorage couplers is filled with a material that is rigid and cohesive per se.

The invention provides a structural element with multifunctional applications and in which insulation and inner coverings can be integrated without the disadvantages of an exclusively firmly-bonded connection. By means of the interlocking of the anchorage couplers, a particularly good connection between the first and the second layers is achieved without the formation of thermal bridges by the anchorage couplers.

Very good interlocking is achieved if the anchorage couplers of the profiles have inwardly-projecting base bars that have interlocking retention bars on their inside ends, and it is expedient if the retention bars project outwardly from both sides of the inner ends of the base bars.

With regard to the inherent durability of the structural element, the metal profile can be an open profile with essentially smooth and/or plane outer surfaces, ie, there is no need to resort to expensive hollow profiles.

Very good insulation properties are achieved if a plastics foam is introduced into the space between the profiles and allowed to cure therein.

On the other hand, good strength values and low weight can alternatively be achieved if a foamed aluminum is introduced into the space between the profiles and allowed to harden therein.

With regard to the strength standards generally desired in vehicle construction, it is advisable for at least one of the profiles to be a metal profile, and especially for at least one of the profiles to be a stainless steel profile.

In another variant that is advantageous in many cases due to its cost effectiveness and light weight, at least one of the profiles is composed of aluminum or an aluminum alloy. Especially in vehicle construction, it can be advantageous if the profile of the first layer is composed of a material different from that of the profile of the second layer, and in most cases, but not obligatorily so, the outer layer will a metal layer and the inner layer a layer of plastics material.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 shows a first embodiment of a plate-shaped structural element of the invention in a partial perspective view;

FIG. 2 shows a second embodiment of the invention having a bowl-shaped design in a view similar to that of FIG. 1; and

FIGS. 3 to 7 show other embodiments of structural elements of the invention, all as partial cross sections.

### DETAILED DESCRIPTION OF THE INVENTION

In the drawings, like numerals indicate like elements throughout. Certain terminology is used herein for convenience only and is not to be taken as a limitation on the present invention. The embodiments illustrated below are not intended to be exhaustive or to limit the invention to the precise form disclosed. These embodiments are chosen and described to best explain the principle of the invention and its application and practical use and to enable others skilled in the art to best utilize the invention.

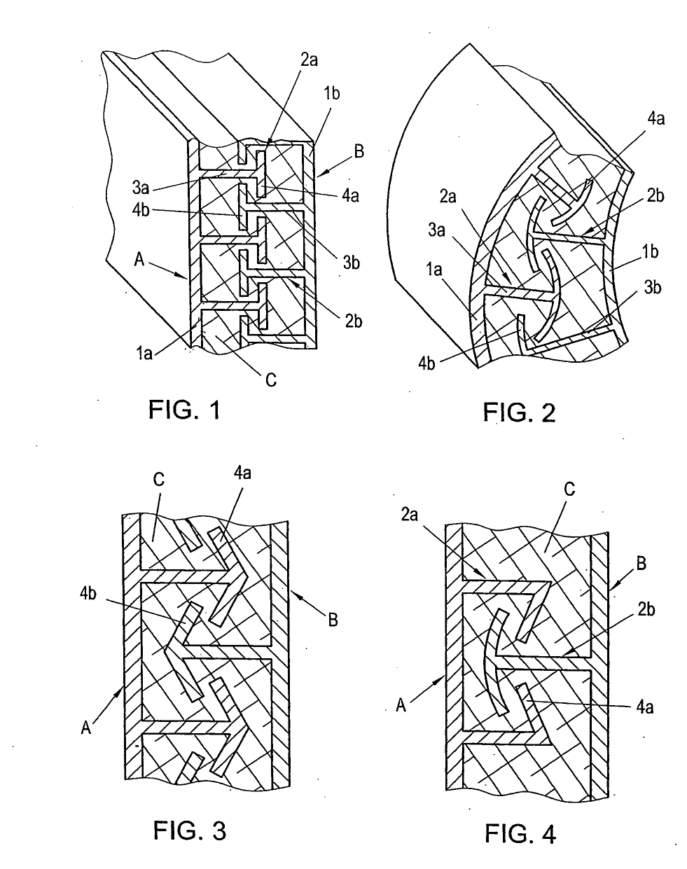

The structural element shown in FIG. 1 is basically composed of three layers, namely, a first layer A, a second layer B, and an intermediate layer C disposed between said first and second layers.

The first layer A is designed as a profile 1a of, say, an aluminum alloy, and it has a smooth and plane outer surface and inwardly-projecting anchorage couplers 2a. The latter consist of base bars 3a, which project outwardly from the base of the profile 1a and which have retention bars 4a on their inner ends, each anchorage coupler having an overall T-shape.

The layer B opposite the first layer A is also a profile 1b and is mirror-inverted relative to the first profile 1a, and in this embodiment it is identical to the latter, ie, it has the same anchor elements 2b consisting of base bars 3b and retention bars 4b.

An essential feature of the present invention is the positive interconnection of the three layers A, B, and C, whereby the structural element is not dependent on the adhesive properties of the layer C with regard to the outer layers A and B, said layer C being usually composed of plastics material. This does not mean, however, that such adhesive properties should not or may not be present in the embodiment of the invention. Strains occurring transversely to the structural element, as created by compressive stress zones in this embodiment, can be optimally absorbed by the mutually interlocking sections of the anchorage couplers and the plastics material disposed between them. In most cases, the intermediate layer C should, of course, provide heat insulation and frequently also sound insulation. Thermal bridges will not form if plastics material is present between the anchorage couplers 2a, 2b of the inner and outer layers.

The material used for the intermediate layer C can be selected according to the field of application, preference being given to plastics foams that can be easily introduced into the interspace and allowed to cure therein. Examples of such foams are polymethane foam, as well as other materials such as foamed aluminum. Examples of known foamed aluminum products are marketed under the brand name ALULIGHT® (supplied by Alulight International GmbH). Non-foamed synthetic resins, etc., are also possible.

The embodiment according to FIG. 2 shows a section of a bowl-shaped structural element, wherein the outer profile 1a and the inner profile 1b are curved in one direction. The anchorage couplers 2a and 2b also have base bars 3a, 3b. However, in this case the retention bars 4a, 4b are curved, giving the anchorage couplers a mushroom shape.

In general, it should be noted at this juncture that the two profiles 1a, 1b can differ from each other in every respect. Although in most cases both of the profiles 1a, 1b will be composed of metal, for example, aluminum or stainless steel, with the outer profile 1a usually having the main supporting function, the inner profile, in particular, may alternatively be composed of a plastics material, say, a glass fiber-reinforced or carbon fiber-reinforced material.

Other variants with regard to the configuration of the retention bars are shown in FIGS. 3 to 5. The retention bars 4a, 4b in FIG. 3 are comparable to those in FIG. 2; however, they have a pitched roof shape.

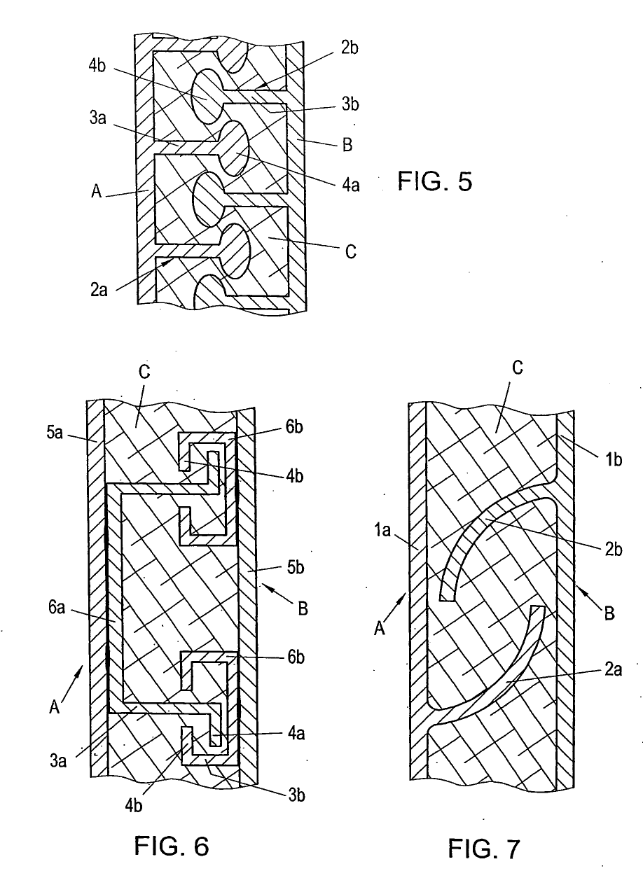

FIG. 4 shows that the anchorage couplers 2a associated with the first layer A can be configured differently than the anchorage couplers 2b associated with the second layer B. The anchorage couplers 2a resemble those illustrated in FIG. 3. However, the retention bars 4a only extend to one side. The anchorage couplers 2b in FIG. 4 resemble those illustrated in FIG. 2. The anchorage couplers 2a, 2b represented in FIG. 5 have retention bars 4a, 4b that can be described as thickened regions or heads, or enlargements, of the base bars 3a, 3b.

FIG. 6 illustrates that the anchorage couplers do not have to be formed on the first or second layer A or B. An outer wall 5a is equipped by, say, welding with a separate component having a U-shaped profile 6a, the shanks of which form the base bars 3a and the ends of which are bent over to form retention bars 4a. The second layer B is designed in a similar manner, namely as an outer wall 5b with a separate component having a C-profile 6b welded onto its inner side, the ends of said C-profile being bent over to form retention bars 4b. The base bars 3a interlock with the retention bars 4b so that the retention bars 4a, 4b again mutually interlock.

The profiles 1a, 1b of the embodiment in FIG. 7 comprise integrated anchorage couplers 1a, 1b that are curved in opposite directions and face each other in such a way that their end sections mutually interlock.

It should be clear that only a limited number of possible embodiments has been described above, and that, within the spirit and the scope of the protection claimed, without departing from the broad inventive concept thereof, there are many other possible variants of the invention that can be produced by persons skilled in the art within the scope of their technical skills.

1. A structural element, composed of a first layer (A), an intermediate layer (C), and a second layer (B), characterized in that said first layer (A) and said second layer (B) are profiles having anchorage couplers projecting into said intermediate layer (C), which couplers regionally interlock with the anchorage couplers associated with the respective opposite layer (A or B), and the space between the profiles and their anchorage couplers is filled with a material that is rigid and cohesive per se.

2. A structural element as defined in claim 1, characterized in that the structural element is bowl-shaped.

3. A structural element as defined in claim 1, characterized in that the structural element is plate-shaped.

4. A structural element as defined in claim 1, characterized in that the anchorage couplers of the profiles have inwardly-projecting base bars, said base bars having mutually interlocking retention bars on their inner ends.

5. A structural element as defined in claim 4, characterized in that the retention bars project outwardly from both sides of the inner ends of said base bars.

6. A structural element as defined in claim 4, characterized in that the retention bars project laterally from both sides of the inner ends of said base bars.

7. A structural element as defined in claim 4, characterized in that each of said base bars of first layer (A) has at least one retention bar projecting in a first general lateral direction from a side of the inner end of said base bar of first layer (A), and each of said base bars of second layer (B) has at least one retention bar projecting in a second general lateral direction opposite from said first general lateral direction from a side of the inner end of said base bar of second layer (B).

8. A structural element as defined in claim 1, characterized in that the anchorage couplers of the profiles have inwardly-projecting base bars, said base bars having mutually interlocking enlargements on their inner ends.

9. A structural element as defined in claim 1, characterized in that the anchorage couplers of one of said first and second layers (A or B) comprise bars that initially extend into said intermediate layer (C) toward the other of said first and second layers (B or A) and ultimately extend laterally to comprise retention sections that provide a regionally interlocking arrangement of the anchorage couplers.

10. A structural element as defined in claim 9, characterized in that the anchorage couplers are generally arcuate.

11. A structural element as defined in claim 1, characterized in that the anchorage couplers are defined by separate components welded to inner surfaces of said first and second layers (A,B).

12. A structural element as defined in claim 11, characterized in that the separate components have regionally interlocking U-shaped and C-shaped profiles.

13. A structural element as defined in claim 1, characterized in that the metal profile is an open profile with a substantially smooth and/or plane outer surface.

14. A structural element as defined in claim 1, characterized in that a plastics foam is introduced into the space between said profiles and allowed to cure therein.

15. A structural element as defined in claim 1, characterized in that an aluminum foam is introduced into the space between said profiles and allowed to harden therein.

16. A structural element as defined in claim 1, characterized in that at least one of said profiles is a metal profile.

17. A structural element as defined in claim 1, characterized in that at least one of said profiles is a stainless steel profile.

18. A structural element as defined in claim 1, characterized in that at least one of said profiles is an aluminum or aluminum alloy profile.

19. A structural element as defined in claim 1, characterized in that a said profile of said first layer (A) is composed of a material different from that of a said profile of the second layer (B).
